(19) United States
(12) Patent Application Publication
(10) Pub. No.: US 2017/0253117 A1
(43) Pub. Date: Sep. 7, 2017

(54) BEARING STRUCTURE AND ASSEMBLY METHOD FOR SAME

(71) Applicant: Showa Corporation, Gyoda-shi (JP)

(72) Inventors: Kazunori OOMIYA, Haga-gun (JP); Shou UMEZAWA, Haga-gun (JP); Yusuke USUNE, Haga-gun (JP)

(73) Assignee: Showa Corporation, Gyoda-shi (JP)

(21) Appl. No.: 15/277,457

(22) Filed: Sep. 27, 2016

(30) Foreign Application Priority Data
Mar. 2, 2016 (JP) 2016-039897

(51) Int. Cl. B60K 17/24; F16C 27/06

(52) U.S. Cl. CPC B60K 17/24; F16C 27/066; F16C 2202/04; F16C 2204/20; F16C 2223/70; F16C 2226/12; F16C 2326/43

(57) ABSTRACT

A bearing structure includes a bearing that supports a propeller shaft, an annular vibration isolating member fitted over the bearing, an outer ring attached to the vibration isolating member and having an outer-peripheral fitting surface, and a bracket attached to a vehicle body and having an inner-peripheral fitting surface that is fitted to the outer-peripheral fitting surface. Both the bracket and the outer ring are formed of an aluminum material. An anodized aluminum layer is formed on at least one of the inner-peripheral fitting surface and the outer-peripheral fitting surface. Because of the above mentioned features, the bearing structure that has a light weight and is inexpensive and productive.

### CROSS-REFERENCE TO RELATED APPLICATION

The present application claims priority under 35 U.S.C. §119 to Japanese Patent Application No. 2016-039897, filed on Mar. 2, 2016. The contents of this application are incorporated herein by reference in their entirety.

### BACKGROUND OF THE INVENTION

1. Field of the Invention

The present invention relates to a bearing structure and an assembly method for the bearing structure.

2. Description of the Related Art

A propeller shaft is a shaft in a vehicle that transmits power between a transmission mounted on a front side of the vehicle and a final reduction gear mounted on a rear side of the vehicle, and includes at least two universal joints and steel pipes. When the length of the shaft between the universal joints exceeds a predetermined value, another universal joint may be arranged midway between the existing universal joints, and a bearing structure may be arranged near this universal joint.

The bearing structure includes a ball bearing fitted over a shaft member of the propeller shaft, a rubber vibration isolator fitted over the ball bearing, and a bracket that holds and attaches the rubber vibration isolator to a vehicle body floor. Metal rings is vulcanized and bonded to the bore diameter side and the outside diameter side of the rubber vibration isolator. The ball bearing is fitted into an inner ring that is the bore diameter-side metal ring, and an outer ring that is the outside diameter-side metal ring is held by the bracket.

The bracket includes a cylindrical ring portion and a leg portion joined to a substantial lower half of the ring portion by welding and having a planar portion attached to a lower surface of the vehicle body and extending in a lateral direction. The outer ring is fitted into the ring portion. To prevent possible slip-out of the outer ring and possible rotation of the rubber vibration isolator (the rubber vibration isolator may have up-down directionality) during use, the fitting between the ring portion and the outer ring involves what is called “press fitting” with a tightening margin. A bore diameter part of the ring portion and an outside diameter part of the outer ring are formed by accurate molding.

The bracket is typically formed of a steel plate. However, for example, DE 10/2004/041739 A discloses that the bracket is formed of an aluminum material in order to reduce the weight of the bracket. A technique for preventing the slip-out is described, for example, in Japanese Patent Application Laid-open No. H10-16585 and Japanese Translation of PCT Application No. 2007-521450. Japanese Patent Application Laid-open No. H10-16585 describes a technique for crimping and fitting the outer ring onto the ring portion. Japanese Translation of PCT Application No. 2007-521450 describes a technique for snap-engaging the outer ring with the ring portion.

### SUMMARY OF THE INVENTION

For example, when the bracket is formed of an aluminum material and the outer ring is formed of a steel plate, a press fitting tightening margin (tightening margin) may vary in a high- or low-temperature environment due to a difference in coefficient of linear expansion between the aluminum material and the steel plate, leading to a reduced holding force. Furthermore, electrolytic corrosion may occur to reduce the holding force. This problem is solved by also forming the outer ring using an aluminum material. However, when the tightening margin is increased to provide an adequate holding force, galling (a phenomenon in which front layers of fitting surfaces are scraped off) is likely to occur when the outer ring is press-fitted into the ring portion. In this case, disadvantageously the adequate tightening margin fails to be provided, preventing the needed holding force from being exerted.

The techniques in Japanese Patent Application Laid-open No. H10-16585 and Japanese Translation of PCT Application No. 2007-521450 need only a small tightening margin. However, the technique in Japanese Patent Application Laid-open No. H10-16585 involves crimping, which may reduce productivity. The technique in Japanese Translation of PCT Application No. 2007-521450 limits the outer ring to a polymer or a plastic material that allows the outer ring to be snap-engaged with the ring portion. Thus, the material strength of the outer ring may be reduced by high temperature, adhesion of oils and fuels, and the effect of ozone.

The present invention has been developed to solve the above-described problems. An object is to provide a bearing structure that has a light weight and is inexpensive and productive, and an assembly method for the bearing structure.

To accomplish the object, an aspect of the present invention provides a bearing structure including a bearing that supports a rotating shaft, an annular vibration isolating member fitted over the bearing, an outer ring attached to the vibration isolating member and having an outer-peripheral fitting surface, and a bracket attached to a vehicle body and having an inner-peripheral fitting surface that is fitted to the outer-peripheral fitting surface. The bracket and the outer ring are formed of an aluminum material. An anodized aluminum layer is formed on at least one of the inner-peripheral fitting surface and the outer-peripheral fitting surface.

The weight of the bearing structure can be reduced by forming both the bracket and the outer ring using the aluminum material. The anodized aluminum layer is excellent in wear resistance. Thus, when the anodized aluminum layer is formed on at least one of the inner-peripheral fitting surface and the outer-peripheral fitting surface, possible galling of the inner-peripheral fitting surface and the outer-peripheral fitting surface can be suppressed and a predetermined press-fitting holding force can be maintained. The bracket and the outer ring can be integrated together by a simple press-fitting operation without the need for a crimping operation or a snap engagement structure. Consequently, the bearing structure is inexpensive and productive.

In this aspect of the present invention, the anodized aluminum layer is formed only in the bracket.

During press fitting of the outer ring, galling is likely to occur mostly on the inner-peripheral fitting surface. Therefore, forming the anodized aluminum layer only in the bracket allows possible galling to be suppressed and eliminates the need to anodize the outer ring. This correspondingly simplifies a manufacturing process and eliminates the need to take possible degradation of the anodized aluminum layer into account when the vibration isolating member is vulcanized and deposited on the outer ring.

In the above-described aspect of the present invention, the bracket includes an outer-ring fitting portion in which the outer-peripheral fitting surface is formed and a vehicle body attaching portion attached to the vehicle body. The anodized aluminum layer is formed only in the outer-ring fitting portion.

In the above-described aspect of the present invention, the anodized aluminum layer is formed only in the outer-ring fitting portion, allowing formation of an unwanted anodized aluminum layer to be suppressed.

In the above-described aspect of the present invention, the anodized aluminum layer has a Vickers hardness of 150 Hv or more.

In the above-described aspect of the present invention, possible galling of the fitting surface can further be suppressed.

An aspect of the present invention provides an assembly method for a bearing structure including a bearing that supports a rotating shaft, an annular vibration isolating member fitted over the bearing, an outer ring bonded to the vibration isolating member and having an outer-peripheral fitting surface, and a bracket attached to a vehicle body and having an inner-peripheral fitting surface that is fitted to the outer-peripheral fitting surface. The method includes: forming the bracket and the outer ring using an aluminum material, and forming an anodized aluminum layer on at least one of the inner-peripheral fitting surface and the outer-peripheral fitting surface; and press-fitting the inner-peripheral fitting surface and the outer-peripheral fitting surface together, with a press fitting margin set to between 0.1 mm and 0.4 mm.

The weight of the bearing structure can be reduced by forming both the bracket and the outer ring using the aluminum material. The anodized aluminum layer is excellent in wear resistance. Thus, when the anodized aluminum layer is formed on at least one of the inner-peripheral fitting surface and the outer-peripheral fitting surface, possible galling of the inner-peripheral fitting surface and the outer-peripheral fitting surface can be suppressed and a predetermined press-fitting holding force can be maintained. The bracket and the outer ring can be integrated together by an easy press-fitting operation without the need for a crimping operation or a snap engagement structure. Consequently, the bearing structure is inexpensive and productive.

The press fitting margin set to between 0.1 mm and 0.4 mm allows both stabilization of a press fitting load during press fitting and maintenance of a holding force after the press fitting to be achieved in a well-balanced manner.

The aspects of the present invention can provide a bearing structure that has a light weight and is inexpensive and productive, and an assembly method for the bearing structure.

### BRIEF DESCRIPTION OF THE DRAWINGS

FIG. 1 is a top sectional view of a propeller shaft and a bearing structure according to the present embodiment, corresponding to a section taken along line X1-X1 in FIG. 3;

FIG. 2 is a side sectional view of the bearing structure according to the present embodiment, corresponding to a section taken along line X2-X2 in FIG. 3; and

FIG. 3 is a front view of the bearing structure according to the present embodiment.

### DESCRIPTION OF THE PREFERRED EMBODIMENTS

(Configuration of the Propeller Shaft)

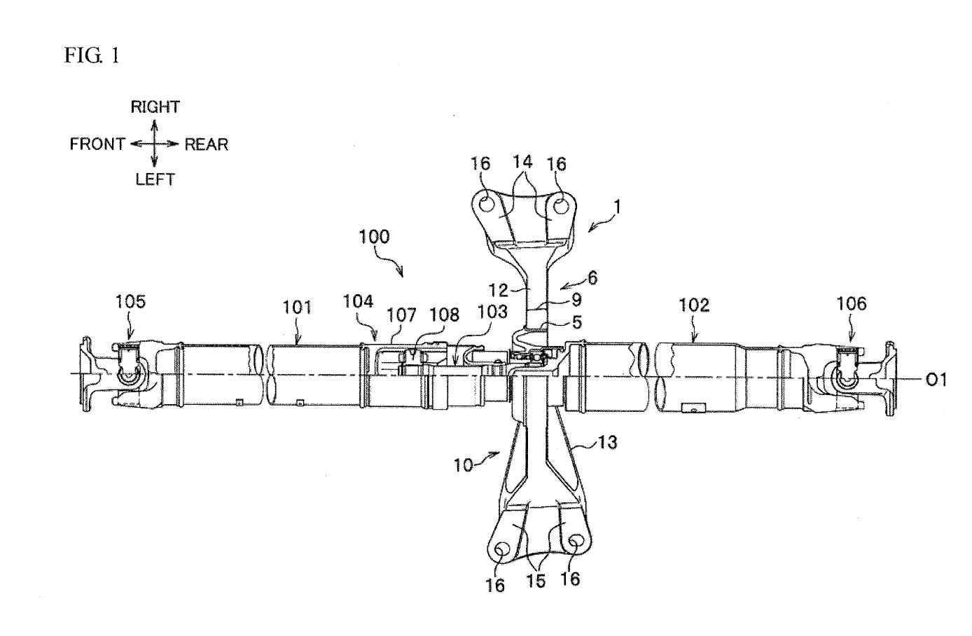

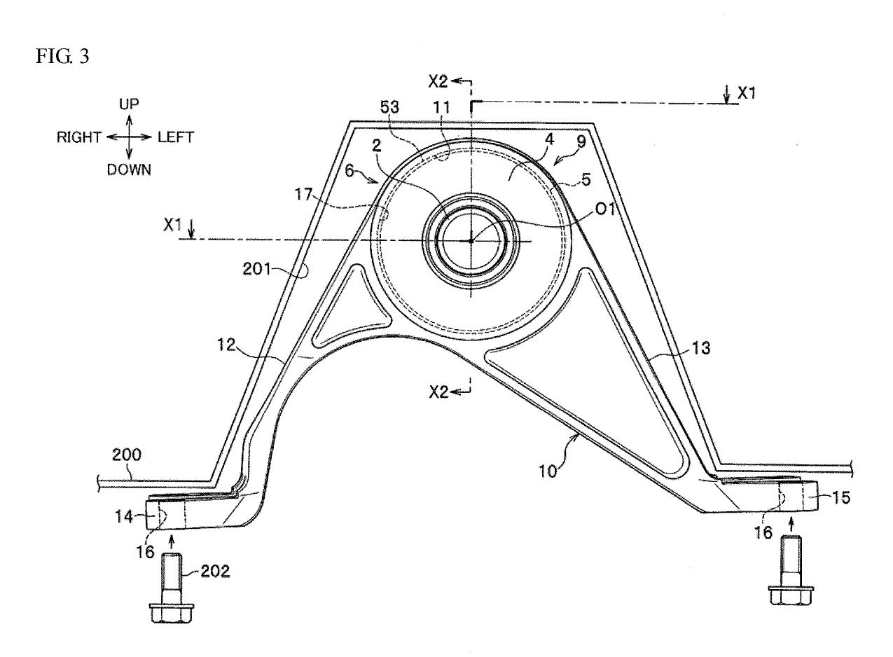

A propeller shaft 100 according to the present embodiment depicted in FIG. 1 is mounted in an FF-based four-wheel drive vehicle. The propeller shaft is a power transmission shaft in the vehicle that transmits power between a transmission (not depicted in the drawings) mounted on a front side of the vehicle and a final reduction gear (not depicted in the drawings) mounted on a rear side of the vehicle. The propeller shaft 100 extends in a front-rear direction and the horizontal direction in a floor tunnel 201 (FIG. 3) formed by recessing a floor panel 200 (FIG. 3) of a vehicle body upward. The propeller shaft 100 rotates around an axis O1. The transmission effect a speed change on power output by an internal combustion engine (motor) arranged under a hood on the front side of the vehicle.

The propeller shaft 100 has a two-piece structure (two-split structure). The propeller shaft 100 includes a first shaft 101 located on the front side, a second shaft 102 located on the rear side, a stab shaft 103 joined to a front end of the second shaft 102, a constant-velocity universal joint 104 that couples the first shaft 101 and the stab shaft 103 together, and a bearing structure 1 that supports the stab shaft 103 so as to make the stab shaft 103 rotatable.

(First Shaft)

A front end of the first shaft 101 is coupled to an output shaft of the transmission via a first joint 105 (cardan joint).

(Second Shaft)

A rear end of the second shaft 102 is coupled to an input shaft of the final reduction gear via a second joint 106 (cardan joint). The rod-like stab shaft 103 is joined to the front end of the second shaft 102. The second shaft 102 and the stab shaft 103 rotate integrally.

(Constant-Velocity Universal Joint)

In the present embodiment, the constant-velocity universal joint 104 is of a tripod type. The constant-velocity universal joint 104 includes an outer ring member 107 fixed to a rear end of the first shaft 101 and having a plurality of grooves formed in an inner peripheral surface of the outer ring member 107 and a trunnion 108 that is fixed to a front end of the stab shaft 103 and that moves through the outer ring member 107 in an axial direction. The constant-velocity universal joint 104 is not limited to the tripod type but may be of a double offset type, a cross groove type, or a birfield type. Otherwise, the constant-velocity universal joint 104 may be omitted from the propeller shaft 100, and the first shaft 101 and the second shaft 102 may be coupled together via a cardan joint.

(Bearing Structure 1)

The bearing structure 1 will be described below with reference to FIGS. 1 to 3. The bearing structure 1 includes a bearing 2 (ball bearing) fitted over the stab shaft 103 to support the stab shaft 103 (propeller shaft 100), a cylindrical inner ring 3 fitted over the bearing 2, an annular vibration isolating member 4 coaxially arranged outside the inner ring 3 in a radial direction, an outer ring 5 arranged outside the vibration isolating member 4 in the radial direction, and a bracket 6 in which the outer ring 5 is press-fitted.

(Vibration Isolating Member)

The vibration isolating member 4 is an annular rubber member and is elastically deformed to attenuate vibration from the stab shaft 103 to reduce transmission of the vibration to the vehicle body.

(Inner Ring)

An inner peripheral surface of the vibration isolating member 4 is vulcanized and deposited on the inner ring 3. Seal members 7 and 8 are provided on an inner peripheral side of the inner ring 3 in front of and behind the bearing 2, respectively, to prevent muddy water, dust, and the like from entering the bearing 2.

(Outer Ring)

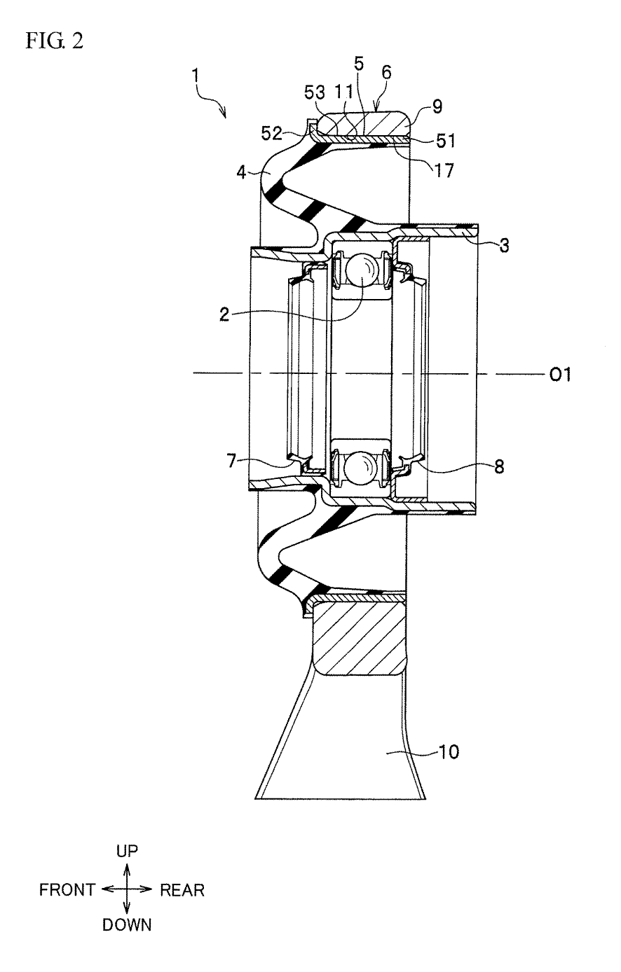

As depicted in FIG. 2, the outer ring 5 has a sectional shape including a body portion 51 extending along a direction of the axis O1 and a flange portion 52 extending outward from a front end of the body portion 51 in the radial direction. An outer peripheral surface of the vibration isolating member 4 is vulcanized and deposited on an inner peripheral surface of the outer ring 5 and a front surface of the flange portion 52. An outer peripheral surface of the body portion 51 is formed into an outer-peripheral fitting surface 53 that is press-fitted to an inner-peripheral fitting surface 11 of the bracket 6. The inner-peripheral fitting surface 11 and the outer-peripheral fitting surface 53 are press-fitted together to a position where a rear surface of the flange portion 52 comes into abutting contact with a front end of an outer-ring fitting portion 9 of the bracket 6. The outer ring 5 is formed of an aluminum material.

(Bracket)

The bracket 6 includes the outer-ring fitting portion 9 and a vehicle body attaching portion 10. The outer-ring fitting portion 9 is shaped like a short tube that penetrates the bracket in the direction of the axis O1. An inner peripheral surface of the outer-ring fitting portion 9 is formed into the inner-peripheral fitting surface 11 that is press-fitted to the outer-peripheral fitting surface 53 of the outer ring 5. Around an outer periphery of the outer-ring fitting portion 9, leg portions 12 and 13 are formed which extend obliquely downward and rightward and obliquely downward and leftward, respectively, and which serve as the vehicle body attaching portion 10. The leg portions 12 and 13 include attaching seat portions 14 and 15 located at lower ends of the leg portions 12 and 13 and extending rightward and leftward, respectively and shaped like horizontal plates. In the attaching seat portions 14 and 15, bolt through-holes 16 are formed which penetrate the attaching seat portions 14 and 15, respectively, in the up-down direction. The bracket 6 is fixed to the vehicle body by placing upper surfaces of the attaching seat portions 14 and 15 on a front panel 200 while the outer-ring fitting portion 9 is arranged in the floor tunnel 201 and inserting bolts 202 into the bolt through-holes 16 from below.

The bracket 6 is formed of an aluminum material (aluminum alloy). In the present embodiment, the outer-ring fitting portion 9 and the vehicle body attaching portion 10 are integrally formed by aluminum die casting. The present embodiment is not limited to aluminum die casting, and extrusion molding or the like may be used. The outer-ring fitting portion 9 and the vehicle body attaching portion 10 may be separate components that are coupled together.

In the bearing structure 1 described above, in the present embodiment, the inner-peripheral fitting surface 11 of the bracket 6 is subjected to anodic oxidation to form an anodized aluminum layer (oxide coating layer) 17 that is excellent in wear resistance. The anodized aluminum layer 17 may be formed on at least one of the inner-peripheral fitting surface 11 of the bracket 6 and the outer-peripheral fitting surface 53 of the outer ring 5. The anodized aluminum layer 17 may optionally be formed only on the outer-peripheral fitting surface 53 of the outer ring 5 or both on the inner-peripheral fitting surface 11 and on the outer-peripheral fitting surface 53.

Common anodic oxidation involves immersing a work piece in a treatment tank storing a treatment solution (electrolytic solution) to form an anodized aluminum layer. Therefore, when the anodized aluminum layer 17 is formed on the inner-peripheral fitting surface 11 or the outer-peripheral fitting surface 53, it is most preferable in view of treatment costs to immerse the whole bracket 6 or outer ring 5 in the treatment tank to form the anodized aluminum layer 17 all over the bracket 6 or the outer ring 5. For the bracket 6, the anodized aluminum layer 17 may be formed all over the outer-ring fitting portion 9 by immersing only the outer-ring fitting portion 9 in the treatment tank while not immersing the vehicle body attaching portion 10 in the treatment tank. If the anodized aluminum layer 17 is formed only on the inner-peripheral fitting surface 11 or the outer-peripheral fitting surface 53, the anodic oxidation may be performed after the whole work piece except for the fitting surface of interest is masked.

The anodized aluminum layer 17 preferably has a Vickers hardness of 150 Hv or more and more preferably 150 to 450 Hv.

The anodized aluminum layer 17 preferably has a thickness of 10 μm to 40 μm.

The anodized aluminum layer 17 preferably has a surface roughness of 12.5 μmRz to 25 μmRz.

A press fitting margin between the inner-peripheral fitting surface 11 and the outer-peripheral fitting surface 53 (a value resulting from subtraction of a bore diameter dimension D2 of the inner-peripheral fitting surface 11 from an outside diameter dimension D1 of the outer-peripheral fitting surface 53) preferably has a value of 0.1 mm to 0.4 mm when the anodized aluminum layer 17 is formed on at least one of the inner-peripheral fitting surface 11 and the outer-peripheral fitting surface 53. Setting the press fitting margin to this value allows both stabilization of a press fitting load during press fitting and maintenance of a holding force after the press fitting to be achieved in a well-balanced manner.

(Effects)

Effects described below are produced by the bearing structure 1 in which both the bracket 6 and the outer ring 5 are formed of the aluminum material and in which the outer-peripheral fitting surface 53 of the outer ring 5 is press-fitted into the inner-peripheral fitting surface 11 of the bracket 6 in which the anodized aluminum layer 17 has been formed.

(1) Since both the bracket 6 and the outer ring 5 are formed of the aluminum material, the weight of the bearing structure 1 can be reduced.

(2) Since both the bracket 6 and the outer ring 5 are formed of the aluminum material, the bracket 6 and the outer ring 5 have the same coefficient of linear expansion. This avoids a disadvantageous situation where a fitting clearance (tightening margin) varies as a result of a variation in temperature to reduce a pressure-fitting holding force.

(3) Since the anodized aluminum layer 17, which is excellent in wear resistance, is formed on the inner-peripheral fitting surface 11 of the bracket 6, when the outer ring 5 is press-fitted into the bracket 6, a possible phenomenon called galling is suppressed in which mainly an outer peripheral edge of a rear end of the outer ring 5 scrapes off a front layer of the inner-peripheral fitting surface 11. Therefore, a predetermined press-fitting holding force is maintained.

(4) The bracket 6 and the outer ring 5 can be integrated together using a simple structure without the need for a crimping operation or a snap engagement structure. Consequently, the bearing structure 1 is inexpensive and productive.

(5) When a process of press-fitting the outer ring 5 is performed with a press fitting load monitored, the accuracy of a press fitting position for automatic assembly is improved because the press fitting load is stabilized.

(6) The anodized aluminum layer 17 makes the bearing structure 1 excellent in electrolytic-corrosion resistance.

The preferred embodiment of the present invention has been described. When the outer ring 5 is press-fitted into the bracket 6, mainly the outer peripheral edge of the rear end of the outer ring 5 often scrapes off the front layer of the inner-peripheral fitting surface 11 of the bracket 6. Therefore, when the anodized aluminum layer 17 is formed on only one of the inner-peripheral fitting surface 11 and the outer-peripheral fitting surface 53, the occurrence of galling can be more effectively reduced when the anodized aluminum layer 17 is formed on the inner-peripheral fitting surface 11. In this case, the outer ring 5 need not be subjected to anodic oxidation, and thus, possible degradation of the anodized aluminum layer need not be taken into account when the vibration isolating member 4 is vulcanized and deposited on the outer ring 5.

The present invention is not limited to the above-described embodiment. For example, if a separate ring member is attached to an outer peripheral portion of the outer ring 5 and press-fitted into the bracket 6, the ring member corresponds to the “outer ring” in the present invention.

### EXPLANATION OF REFERENCE NUMERALS

1 Bearing structure
2 Bearing
3 Inner ring
4 Vibration isolating member
5 Outer ring
6 Bracket
9 Outer-ring fitting portion
10 Vehicle body attaching portion
11 Inner-peripheral fitting surface
53 Outer-peripheral fitting surface
100 Propeller shaft (rotating shaft)

1. A bearing structure comprising:
a bearing that supports a rotating shaft;
an annular vibration isolating member fitted over the bearing;
an outer ring attached to the vibration isolating member and having an outer-peripheral fitting surface; and
a bracket attached to a vehicle body and having an inner-peripheral fitting surface that is fitted to the outer-peripheral fitting surface,
wherein the bracket and the outer ring are formed of an aluminum material, and an anodized aluminum layer is formed on at least one of the inner-peripheral fitting surface and the outer-peripheral fitting surface.

2. The bearing structure according to claim 1, wherein the anodized aluminum layer is formed only in the bracket.

3. The bearing structure according to claim 2, wherein the bracket includes an outer-ring fitting portion in which the outer-peripheral fitting surface is formed and a vehicle body attaching portion attached to the vehicle body, and
the anodized aluminum layer is formed only in the outer-ring fitting portion.

4. The bearing structure according to claim 1, wherein the anodized aluminum layer has a Vickers hardness of 150 Hv or more.

5. The bearing structure according to claim 2, wherein the anodized aluminum layer has a Vickers hardness of 150 Hv or more.

6. The bearing structure according to claim 3, wherein the anodized aluminum layer has a Vickers hardness of 150 Hv or more.

7. An assembly method for a bearing structure including:
a bearing that supports a rotating shaft;
an annular vibration isolating member fitted over the bearing;
an outer ring bonded to the vibration isolating member and having an outer-peripheral fitting surface; and
a bracket attached to a vehicle body and having an inner-peripheral fitting surface that is fitted to the outer-peripheral fitting surface,
the method comprising:
forming the bracket and the outer ring using an aluminum material, and forming an anodized aluminum layer on at least one of the inner-peripheral fitting surface and the outer-peripheral fitting surface; and
press-fitting the inner-peripheral fitting surface and the outer-peripheral fitting surface together, with a press fitting margin set to between 0.1 mm and 0.4 mm.
